(19) United States
(12) Patent Application Publication
(10) Pub. No.: US 2014/0357218 A1
(43) Pub. Date: Dec. 4, 2014

(54) METHOD AND APPARATUS FOR MODERATED ACCESS TO SHARED RADIO SPECTRUM RESOURCES

(71) Applicant: Nokia Siemens Networks Oy, Espoo (FI)

(72) Inventors: Anatoly ANDRIANOV, Schaumburg, IL (US); James KEPLER, Buffalo Grove, IL (US); Ravindra MOORUT, Tower Lakes, IL (US); Rapeepat RATASUK, Hoffman Estates, IL (US); Joseph SCHUMACHER, Glenn Ellyn, IL (US)

(21) Appl. No.: 13/907,461

(22) Filed: May 31, 2013

(51) Int. Cl. H04W 16/14; H04W 4/24

(52) U.S. Cl. CPC H04W 16/14; H04W 4/24
USPC 455/406; 455/454

(57) ABSTRACT

Certain embodiments may relate to communication systems, for example wireless communication systems. For example, wireless communication networks may benefit from moderated access to shared radio spectrum resources. A method may include receiving an identification of radio spectrum resources corresponding to at least one incumbent and available for sharing. The method may also include sharing the radio spectrum resources to at least one radio access network operator. The method may further include maintaining a priority for the at least one incumbent over the at least one operator with respect to the radio spectrum resources.

### BACKGROUND

1. Field

Certain embodiments may relate to communication systems, for example wireless communication systems. For example, wireless communication networks may benefit from moderated access to shared radio spectrum resources.

2. Description of the Related Art

“Authorised Shared Access (ASA). An Innovative Model of Pro-competitive Spectrum Management,” by Nokia Corporation and Qualcomm Corporation is a white paper that is hereby incorporated herein by reference in its entirety. This white paper proposes dynamic sharing of spectrum resources without “real sharing” between operators. In other words, it proposes sharing allocations/assignments of available spectrum resources are static based on strict agreements and dynamic component of sharing is only when and where the shared spectrum is released by incumbent).

Various scenarios for ASA spectrum sharing are possible, including frequency sharing, when the incumbent only uses a subset of the available frequencies; time sharing, when the incumbent does not require continuous, constant access to the spectrum; geographic sharing, when the incumbent uses the spectrum only in a geographically limited area; and combinations of the frequency, time and geographic sharing scenarios.

FIG. 1 illustrates an ASA spectrum sharing architecture according to a contemporary approach. As shown in FIG. 1, the architecture may include an ASA Repository 110, which is a database. This database contains the relevant information on spectrum use by the incumbent 120 in the spatial, frequency and time domains. For the purpose of ASA, an “incumbent” may be defined as a current holder of spectrum rights of use. It is possible that the incumbent has been granted the spectrum rights through an award procedure (e.g., first-come, first-served, beauty contest, and auction) for commercial use. On the other hand however, the incumbent 120 may be viewed as the original or default owner of the spectrum. For example, the incumbent 120 may be a government agency or a regulatory, such as the Department of Defense, the Department of Homeland Security, the Federal Aviation Administration or other spectrum users such as Satellite Services or Broadcasters. The database may add safety margins and deliberate distortions to the actual use data in order to mask the true activity of the incumbent 120. The incumbent 120 may not be willing to give precise information about its spectrum use to ASA licensees, for reasons primarily connected to the nature of its service, which may be defense operations, interference management, network security, emergency services or privacy. Due to the sensitive nature of the incumbent's information, in some cases the ASA repository 110 could be country-specific and under the purview of the National Regulatory Authority (NRA), such as the Federal Communications Commission or the National Telecommunications and Information Administration (NTIA). There could be one or more repositories per country, depending on the ASA band and the incumbent's nature: public or commercial. The ASA repository 110 may be directly managed by the administration or the NRA (illustrated in combination as the administrator/regulator 130) or by the incumbent 120, or be delegated to a trusted third party.

As shown in FIG. 1, the architecture may also include ASA controller 140. The ASA controller 140 computes ASA spectrum availability based on rules built upon ASA rights of use and information on the incumbent's use provided by the ASA repository 110. It connects to the ASA repository 110 through a secure and reliable interface. There could be one or multiple ASA controllers per country. The ASA controller 140 can interface with one or multiple ASA repositories as well as with one or multiple ASA networks. The ASA controller 140 may be managed by the administrator/regulator 130, the ASA licensee(s) 150 or a trusted third party.

ASA network operations, administration and maintenance (OAM) corresponds to the OAM of mobile broadband networks. The OAM in the ASA licensee network takes care of the actual management of the ASA licensed spectrum. In practical terms, the OAM translates into radio resource management (RRM) commands the information on spectrum availability obtained from the ASA controller 140. These commands are then transmitted to base stations 160, 165 in the ASA licensee's network, as contrasted to incumbent base station(s) 125. Based on this information, the base stations 160, 165 enable user devices 170 to access the ASA spectrum or order them to hand off seamlessly to other frequency bands as appropriate subject to, for example, ASA spectrum availability, quality of service (QoS) requirements, data rates or data plans. Information coming from the OAM also allows the base stations 160, 165 to tune to different channels or to power down.

FIG. 2 illustrates interfaces of an ASA spectrum sharing architecture according to a contemporary approach. As shown in FIG. 2, ASA_{—}1 can be an interface between an incumbent 220, 222, 224, 226 and a repository 210, 212. ASA_{—}2 can be an interface between a repository 210, 212 and an ASA database (DB) 211, 213, 215. A firewall 280 between the two databases can be used to protect information on both sides. Not all of the information on incumbent side needs to be shared. So, the firewall 280 can protect sensitive incumbent spectrum use.

As also shown in FIG. 2, ASA_{—}3 can be an interface between ASA DB 211, 213, 215 and ASA licensee 250, 252, 254. This may be internal, as with ASA DB 215 and ASA licensee 254, if the licensee operates its own ASA database. ASA_{—}4.1 and ASA_{—}4.2 can be interfaces from rules DB 290 to the other databases. Moreover, ASA_{—}5 can be an inter repository interface, which can be used for synchronization across country borders or the like.

### SUMMARY

According to certain embodiments, a method may include receiving an identification of radio spectrum resources corresponding to at least one incumbent and available for sharing either at a present time or at one or more future times. The method can also include sharing the radio spectrum resources to at least one radio access network operator. The method may further include maintaining a priority for the at least one incumbent over the at least one operator with respect to the radio spectrum resources.

In certain embodiments, a method can include sharing, by a radio access network operator, radio spectrum resources corresponding to at least one incumbent, wherein the at least one incumbent maintains priority over the radio access network operator with respect to the radio spectrum resources. The method can also include determining whether to continue sharing the radio spectrum resources. The method may further include discontinuing sharing the radio spectrum resources when the determination is negative.

A method, according to certain embodiments, may include determining that shared radio spectrum resources are needed by a radio access network operator. The method can also include obtaining the shared radio spectrum resources, wherein an incumbent corresponding to the shared radio spectrum resources maintains priority over the radio access network operator with respect to the radio spectrum resources.

An apparatus, in certain embodiments, can include at least one processor and at least one memory including computer program code. The at least one memory and the computer program code can be configured to, with the at least one processor, cause the apparatus at least to receive an identification of radio spectrum resources corresponding to at least one incumbent and available for sharing either at a present time or at one or more future times. The at least one memory and the computer program code can also be configured to, with the at least one processor, cause the apparatus at least to share the radio spectrum resources to at least one radio access network operator. The at least one memory and the computer program code can further be configured to, with the at least one processor, cause the apparatus at least to maintain a priority for the at least one incumbent over the at least one operator with respect to the radio spectrum resources.

According to certain embodiments, an apparatus can include at least one processor and at least one memory including computer program code. The at least one memory and the computer program code can be configured to, with the at least one processor, cause the apparatus at least to share, by a radio access network operator, radio spectrum resources corresponding to at least one incumbent, wherein the at least one incumbent maintains priority over the radio access network operator with respect to the radio spectrum resources. The at least one memory and the computer program code can also be configured to, with the at least one processor, cause the apparatus at least to determine whether to continue sharing the radio spectrum resources. The at least one memory and the computer program code can further be configured to, with the at least one processor, cause the apparatus at least to discontinue sharing the radio spectrum resources when the determination is negative.

In certain embodiments, an apparatus can include at least one processor and at least one memory including computer program code. The at least one memory and the computer program code can be configured to, with the at least one processor, cause the apparatus at least to determine that shared radio spectrum resources are needed by a radio access network operator. The at least one memory and the computer program code can also be configured to, with the at least one processor, cause the apparatus at least to obtain the shared radio spectrum resources, wherein an incumbent corresponding to the shared radio spectrum resources maintains priority over the radio access network operator with respect to the radio spectrum resources.

An apparatus, in certain embodiments, may include means for receiving an identification of radio spectrum resources corresponding to at least one incumbent and available for sharing either at a present time or at one or more future times. The apparatus may also include means for sharing the radio spectrum resources to at least one radio access network operator. The apparatus may further include means for maintaining a priority for the at least one incumbent over the at least one operator with respect to the radio spectrum resources.

According to certain embodiments, an apparatus may include means for sharing, by a radio access network operator, radio spectrum resources corresponding to at least one incumbent, wherein the at least one incumbent maintains priority over the radio access network operator with respect to the radio spectrum resources. The apparatus may also include means for determining whether to continue sharing the radio spectrum resources. The apparatus may further include means for discontinuing sharing the radio spectrum resources when the determination is negative.

In certain embodiments, an apparatus may include means for determining that shared radio spectrum resources are needed by a radio access network operator. The apparatus may also include means for obtaining the shared radio spectrum resources, wherein an incumbent corresponding to the shared radio spectrum resources maintains priority over the radio access network operator with respect to the radio spectrum resources.

According to certain embodiments, a computer-readable medium (for example, a non-transitory computer-readable medium or a signal) may be encoded with instructions that, when executed in hardware, perform a process. The process can include receiving an identification of radio spectrum resources corresponding to at least one incumbent and available for sharing either at a present time or at one or more future times. The process can also include sharing the radio spectrum resources to at least one radio access network operator. The process can further include maintaining a priority for the at least one incumbent over the at least one operator with respect to the radio spectrum resources.

In certain embodiments, a computer-readable medium (for example, a non-transitory computer-readable medium or a signal) may be encoded with instructions that, when executed in hardware, perform a process. The process can include sharing, by a radio access network operator, radio spectrum resources corresponding to at least one incumbent, wherein the at least one incumbent maintains priority over the radio access network operator with respect to the radio spectrum resources. The process can also include determining whether to continue sharing the radio spectrum resources. The process can further include discontinuing sharing the radio spectrum resources when the determination is negative.

A computer-readable medium (for example, a non-transitory computer-readable medium or a signal) may, in certain embodiments, be encoded with instructions that, when executed in hardware, perform a process. The process can include determining that shared radio spectrum resources are needed by a radio access network operator. The process can also include obtaining the shared radio spectrum resources, wherein an incumbent corresponding to the shared radio spectrum resources maintains priority over the radio access network operator with respect to the radio spectrum resources.

### BRIEF DESCRIPTION OF THE DRAWINGS

For proper understanding of the invention, reference should be made to the accompanying drawings, wherein:

FIG. 1 illustrates an ASA spectrum sharing architecture according to a contemporary approach.

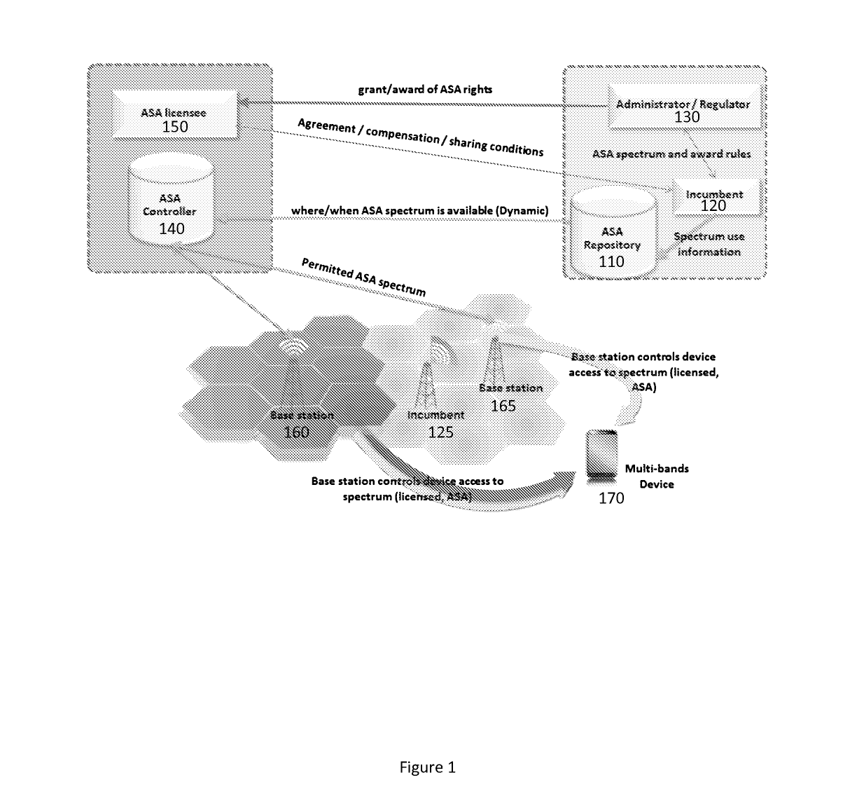

FIG. 2 illustrates interfaces of an ASA spectrum sharing architecture according to a contemporary approach.

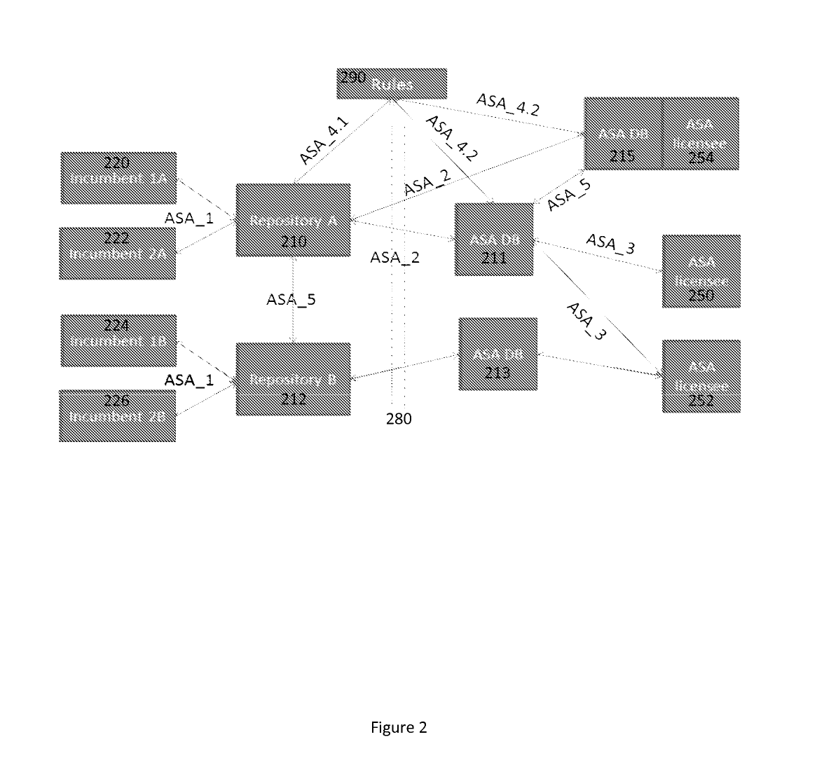

FIG. 3 illustrates an ASA spectrum sharing architecture according to certain embodiments.

FIG. 4 illustrates a method of a broker agent according to certain embodiments.

FIG. 5 illustrates another method of a broker agent according to certain embodiments.

FIG. 6 illustrates a method of an operator according to certain embodiments.

FIG. 7 illustrates another method of an operator according to certain embodiments.

FIG. 8 illustrates a signal flow diagram of methods according to certain embodiments.

FIG. 9 illustrates a system according to certain embodiments.

### DETAILED DESCRIPTION

Certain embodiments may provide moderated access to shared spectrum, such as spectrum associated with authorized shared access (ASA). More specifically, certain embodiments provide the architecture and mechanisms for moderated access to shared radio spectrum resources by multiple operators. Thus, an ASA implementation design according to certain embodiments can provide an architecture and methods supporting the real sharing of spectrum resources between operators, referring to co-usage of frequencies between operators that may be competitors, as opposed to a situation in which access to spectrum under ASA remains on an exclusive basis because the ASA licensee, who has signed an agreement with the incumbent maintains full and exclusive rights as a primary user of the relevant spectrum.

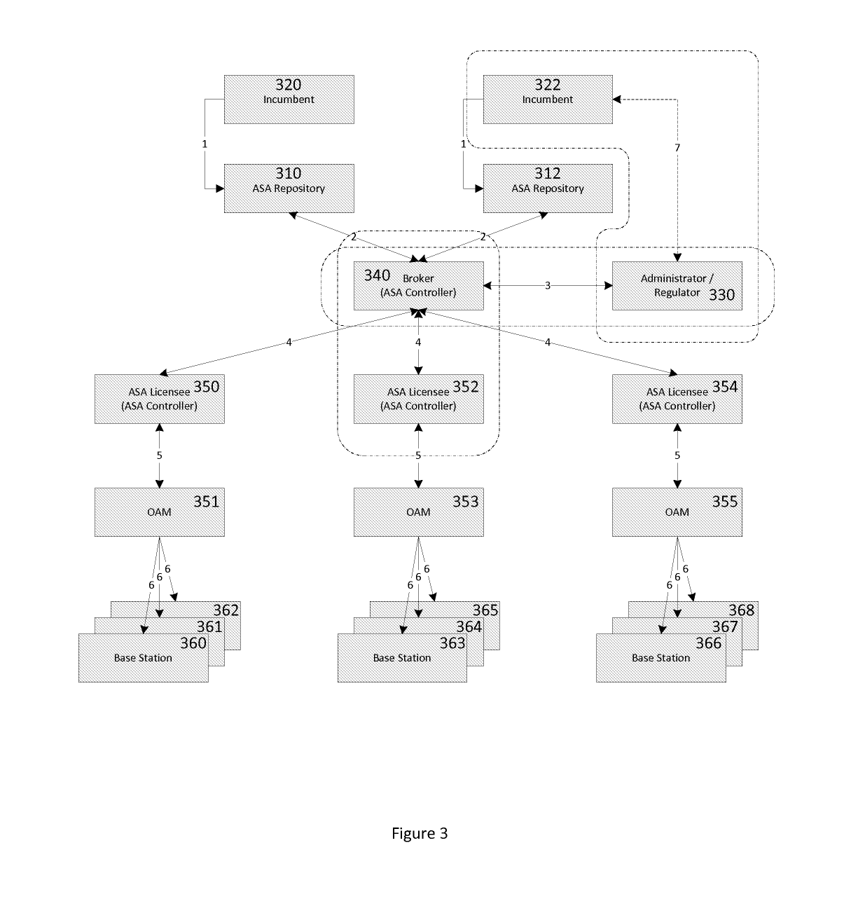

FIG. 3 illustrates an ASA spectrum sharing architecture according to certain embodiments. As shown in FIG. 3, interface 1 can, similar to ASA_{—}1, connect incumbent 320, 322 to ASA repository 310, 312. Precise spectrum use information such as specific frequencies (radio resources), locations, and time can be exchanged or provided over this interface.

Interface 2 can connect ASA repository 310, 312 to broker 340, which can be an ASA controller. Notifications about available radio resources, such as generalized location, available spectrum, and time, can be provided over this interface. Likewise, this interface can be used to provide notifications to immediately vacate the shared spectrum. Thus, in some ways this interface may be similar to ASA_{—}2. One difference, however, may be that interface 2 can be configured to exchange different data.

Interface 3 can connect broker 340 to administrator/regulator 330. This interface can provide guidelines on shared spectrum usage such as: minimum utilization targets, allowed interference levels (including location areas, power spectral density (PSD), max duration, and the like), permission to transfer the radio resources, time to vacate the spectrum, categories of priority users (for example, government and public safety) and minimum service allocations to these, cost, and similar items. This interface may in some ways be similar to ASA_{—}4.1 and ASA_{—}4.2 but may exchange different data.

Interface 4 can connect broker 340 to an ASA licensee (for example mobile network operator (MNO)) 350, 352, 354. The interface can provide resource allocations with associated costs and minimum utilization level targets. The interface can also be used to communicate resource revocations, including notifications to immediately vacate. The interface may be similar in some ways to ASA_{—}3, but may be used to exchange different data.

Interface 5 can connect an ASA licensee 350, 352, 354 to OAM 351, 353, 355. This interface can provide resource allocations with associated costs and minimum utilization level targets. The interface can also provide resource revocations including the notifications to immediately vacate. Moreover, utilization and accounting data can be provided over this interface. This interface may be an internal interface between functions within network management (NM) domain or a standardized interface (for example, Itf-N) between NM and element management (EM).

Interface 6 can connect OAM 351, 353, 355 to base stations 360-68. This interface can convey configuration management (CM) and performance management (PM) data. This may be a standardized interface (for example, Itf-N) between NM and EM, but could also be implemented as a proprietary interface between EM and network elements (NEs).

Interface 7 can connect incumbent 322 to administrator/regulator 330. The interface can be used for communicating allowed interference levels, including location areas, PSD, max duration, and the like. The interface can also provide an indication of time to vacate the spectrum. Furthermore, the interface can be used to communicate categories of priority users (for example, government and public safety) and minimum service allocations to these. The interface may be proprietary, for example where the incumbent 322 is the administrator/regulator 330, and may otherwise be standardized.

Using dashed lines, FIG. 3 illustrates possibilities for combined roles of broker 340 and ASA licensee 352 (for example, when one of the licensees acts as a broker), broker 340 and administrator/regulator 330 (for example, when the regulation authority acts as a broker), and incumbent 322 and administrator/regulator 330 (for example, when a government agency acts as both incumbent operator and regulator).

Interface 1 between incumbent 320, 322 and ASA repository 310, 312 can be unidirectional and can carry information about spectrum use by the incumbent, such as spectrum, location, and/or time. The time component may include prediction/planning data and immediate notifications.

Various methods are possible. In these methods, the incumbent may have higher priority for the shared radio spectrum resources—whenever the incumbent needs to use the shared radio resources, it informs the broker entity which in turn informs the MNOs using the shared radio resources. The MNOs must comply and vacate/evacuate the shared radio resources within specified time (immediately).

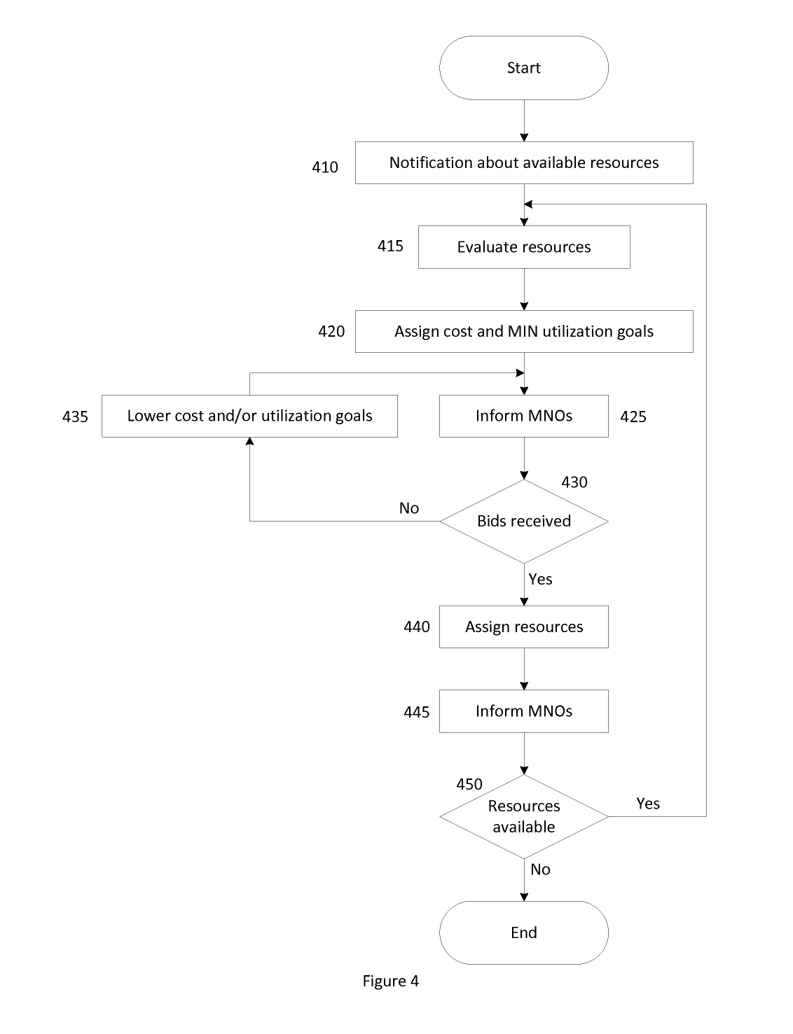

FIG. 4 illustrates a method of a broker agent according to certain embodiments. As shown in FIG. 4, a broker agent can advertise the available incumbent radio spectrum resources as, for example, a reverse auction scenario. At 410, the incumbent can inform the broker entity about radio resources available for sharing, including information such as frequencies, geographical locations, and time frame. For example, the time period for sharing may be either at the present time, such as immediately, or at one or more future times. In a particular case, a broker may receive information that the spectrum would be available in the future, such as in one hour. Then, at 415, the broker entity can evaluate the available radio resources and can, 420, assign cost and minimum utilization level goals.

At 425, the broker entity can inform the MNOs about available spectrum resources and associated costs and utilization goals. Each MNO can evaluate its own current radio resource utilization levels and needs in the geographical areas where shared spectrum is offered, can compute the projected profitability/revenue and utilization levels for the new radio spectrum resources, and can make a decision whether to accept or reject the offered radio spectrum resources.

The broker can determine, at 430, whether bids for the resources have been offered. If no MNO has accepted the shared radio resources offer, at 435 the broker entity can lower the cost and/or minimum utilization level goals and can repeat the offer process. For example, referring to the illustrative case mentioned above, the broker can have an auction for spectrum to be used from 9-10 AM. The winner would get that spectrum, if it becomes available at the prescribed time.

Once a bid is received, at 440, the broker entity can assign the available radio resources according to the sharing request(s) received from the operators. This assignment can be in specific geographical location(s) for pre-defined period(s) of time. The broker can also, at 445, inform the MNOs of this assignment. Each MNO receiving the allocations can perform the network re-configuration and start using the radio resources. Moreover, the MNO using the shared radio spectrum resources can continuously re-evaluate the utilization and profitability of these resources and if profitability and/or minimum utilization targets are not met, can inform the broker entity and release the shared spectrum resources before a pre-defined period of time expires.

Thus, at 450, the broker entity can reevaluate whether resources are available, and can continue performing the above-described process as long as resources are available.

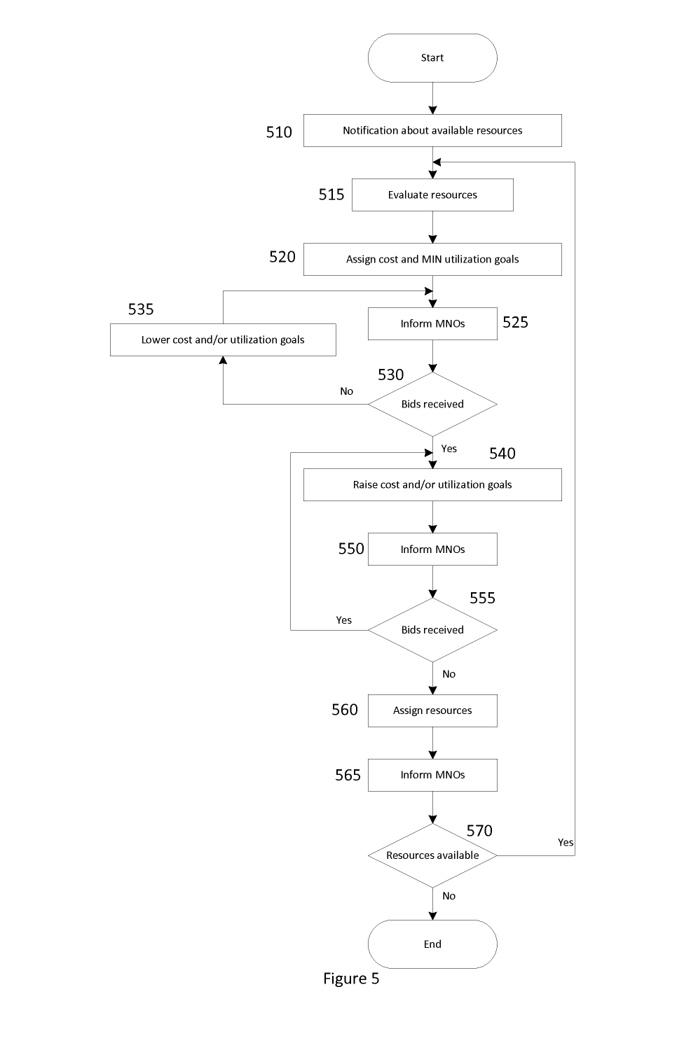

FIG. 5 illustrates another method of a broker agent according to certain embodiments. As shown in FIG. 5, a broker agent can evaluate bids from operators for available incumbent radio spectrum resources as, for example, a forward auction scenario. At 510, an incumbent can inform the broker entity about radio resources available for sharing, including such information as frequencies, geographical locations and time frame.

At 515, the broker entity can evaluate the available radio resources and can, at 520, assign cost and minimum (MIN) utilization goals. At 525, the broker entity can inform the MNOs about available spectrum resources. Each MNO can evaluate its current radio resource utilization levels and needs in the geographical areas where shared spectrum is offered, can compute projected profitability/revenue and utilization levels for the new radio spectrum resources, and can make a decision whether to bid or not for the offered radio spectrum resources, the bid amount and projected utilization levels.

At 530, the broker entity can determine whether bids have been received. If no bids have been received, at 535, the broker entity can lower cost and/or utilization goals. If bids are received, at 540, the broker entity can evaluate the bids received from MNOs based on the bid amount and/or minimum utilization level goals and raise cost and/or utilization goals at 540. The broker can then inform the MNOs at 550, and determine at 555 whether any bids in response to the raised cost or utilization goals have been received. If bids have been received, the raising and soliciting new bids can continue. In other words, the broker entity can inform the MNOs about current bid amounts and utilization goals and repeat the process until the highest bidder MNOs are identified.

At 560, the broker entity can assign the available radio resources according to the bids received from the operators, for example in specific geographical locations for a pre-defined period of time, and can inform the MNOs at 565.

The MNO receiving the allocations can perform the network re-configuration and start using the radio resources. Moreover, the MNO(s) using the shared radio spectrum resources can continuously re-evaluate the utilization and profitability of these resources and if profitability and/or minimum utilization targets are not met, can inform the broker entity and release the shared spectrum resources, even before the pre-defined period of time expires.

Moreover, at 570, the broker entity can reevaluate whether resources are available, and can continue performing the above-described process as long as resources are available.

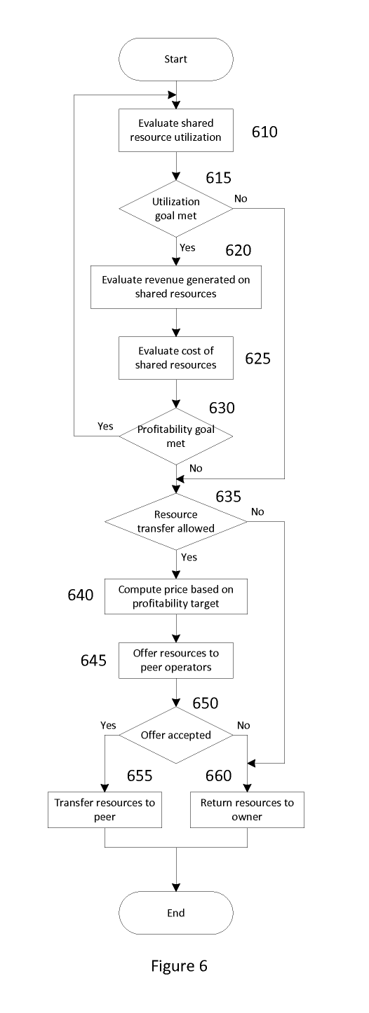

FIG. 6 illustrates a method of an operator according to certain embodiments. As shown in FIG. 6, an operator or current owner/user of the radio spectrum resources can evaluate resource utilization/profitability and offer the radio spectrum resources to peers.

For example, at 610 the operator can evaluate shared resource utilization based on targets for resource utilization and/or profitability specific to the shared radio resources. For example, the targets may include revenue generated by the users on shared radio resources, which may be evaluated at 620. The targets may also, at 625, include or take into account current cost of ownership (for example, borrowing or leasing) for the shared resources. The targets can also include resource utilization, which may be measured in terms of percent used resource blocks, number of supported users, overall throughput, or the like.

Periodically, at 615, the operator can monitor the shared radio resource utilization levels and profitability. For example, the monitoring can occur at the end of each PM/key performance indicator (KPI) reporting interval. The operator can then detects that either resource utilization levels (at 615) or profitability (at 630) do not meet the pre-set targets for a pre-defined number of monitoring intervals, operator makes a decision to either offer, at 645, the shared radio resources or a subset of them to peer operators at a price computed, at 640, based on the target profitability level, or return, at 660, the borrowed radio resources back to the owner, when the operator is not an owner of the shared radio resources, in order to comply with committed utilization levels or to avoid financial losses due to profitability levels significantly below the targets. Before making an offer to a peer, the owner may check, at 635, whether resource transfer is allowed.

If the offer is accepted at 650, the owner can transfer the resources to the peer at 655. Otherwise, if the offer is not accepted, the owner can, at 660, return resources to the owner.

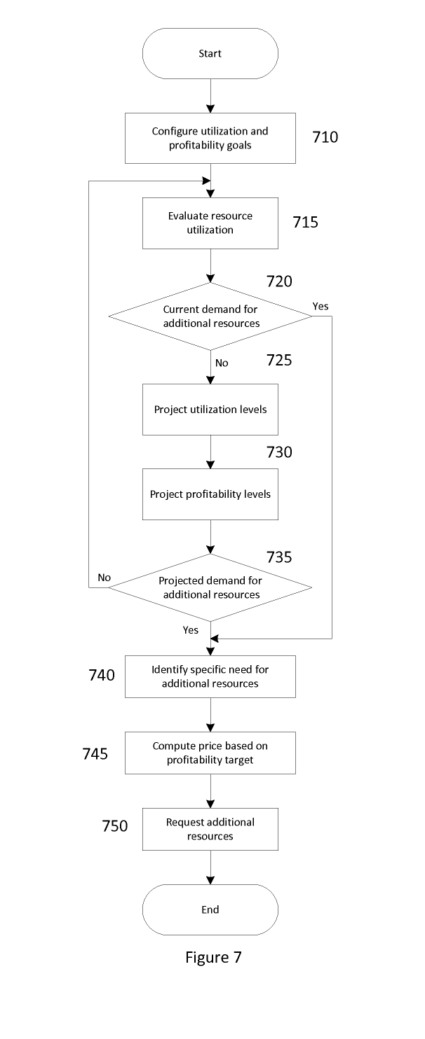

FIG. 7 illustrates another method of an operator according to certain embodiments. As shown in FIG. 7, an operator lacking radio spectrum resources can evaluates resource needs/potential profitability and can request them from peers. For example, at 710 an operator can configure targets for resource utilization specific to non-shared resources. For example, resource utilization can be expressed in terms of percent used resource blocks, number of supported users, overall throughput, or the like.

The operator can periodically monitor the currently owned radio resource utilization levels, at 715, and profitability, for example at the end of each PM/KPI reporting interval. The operator can also determine, at 720, whether there is a current demand for additional radio resources (for example, number of additional UEs to be served). Moreover, the operator can further determine, at 725, projected utilization levels on additional radio resources, based for example, on simulation. Similarly, based for example on simulation, at 730, the operator can project profitability levels on additional radio resources.

If operator detects that the current resource utilization meets the targets (is high enough) and there is a potential for meeting the utilization and profitability targets on additional resources, operator makes a decision to, at 740, identify the specific need for additional resources (for example, specific locations, bandwidth, or the like) and/or, at 745, identify the maximum acceptable cost of additional radio resources in order to maintain the profitability targets. Finally, at 750, the operator can request the additional radio resources either from peers or from a broker agent.

In another embodiment, not shown, a proxy operator, for example a current owner of radio spectrum resources, can re-sell services to peer operators in a dynamic radio access network (RAN) sharing scenario.

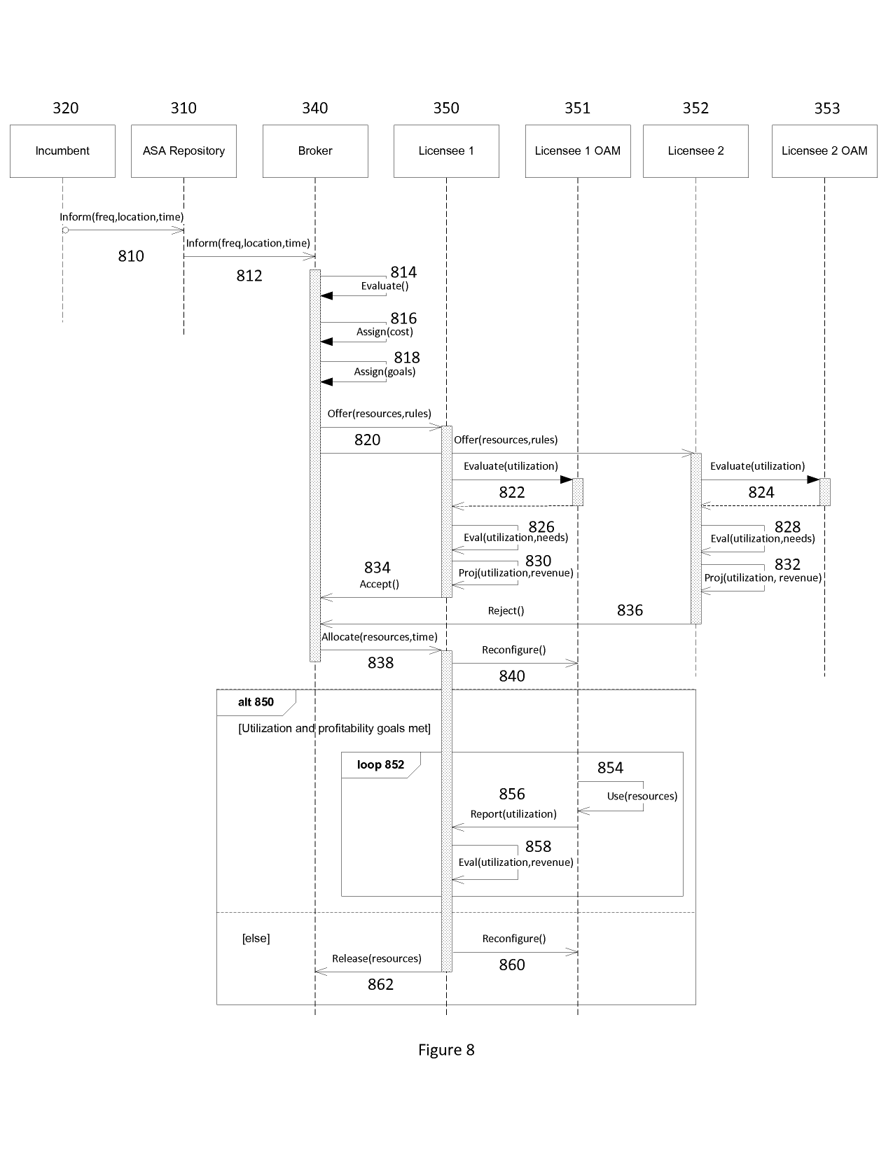

FIG. 8 illustrates a signal flow diagram of the methods according to certain embodiments of the invention, such as those illustrated in FIGS. 4-7. As shown in FIG. 8, at 810 an incumbent 320 can send a message to an ASA repository 310 informing regarding frequency, location, time, and the like for radio spectrum resources. At 812, the ASA repository 310 can forward this information to broker 340. Alternatively, the ASA repository 310 can be the original source of the details regarding frequency, location, and time. At 814, the broker 340 can evaluate the resources and can, at assign cost (at 816) and goals (at 818).

Then, at 820, the broker 340 can send an offer including an identification of the resources and associated rules to Licensee 1 350 and Licensee 2 352. By respectively communicating with their OAMs 351, 353, the licensees 350, 352, can evaluate utilization at 822, 824. Moreover, the licensees 350, 352 can respectively evaluate their utilization needs (at 826, 828) and projected revenue (at 830, 832). In the particular case illustrated in FIG. 8, Licensee 1 350 accepts the offer (at 834) and Licensee 2 352 rejects the offer (at 836), although in other cases both could accept or both could reject. Moreover, there may be additional licensees offered the resources.

At 838, the broker 340 can allocate resources for a predetermined amount of time, to Licensee 1 350. Then, at 840, Licensee 1 350 can send a reconfiguration message to its OAM 351.

As an alternative at 850, the Licensee 1 350 can monitor whether utilization and profitability goals are met using loop 852. The loop 852 can include, at 854, use of resources by OAM 351, report of that use at 856, and evaluation of that reported use at 858. Based on the results of such periodic evaluation, the Licensee 1 350 can reconfigure the resources at 860 and can signal to broker 340 a release of the resources at 862.

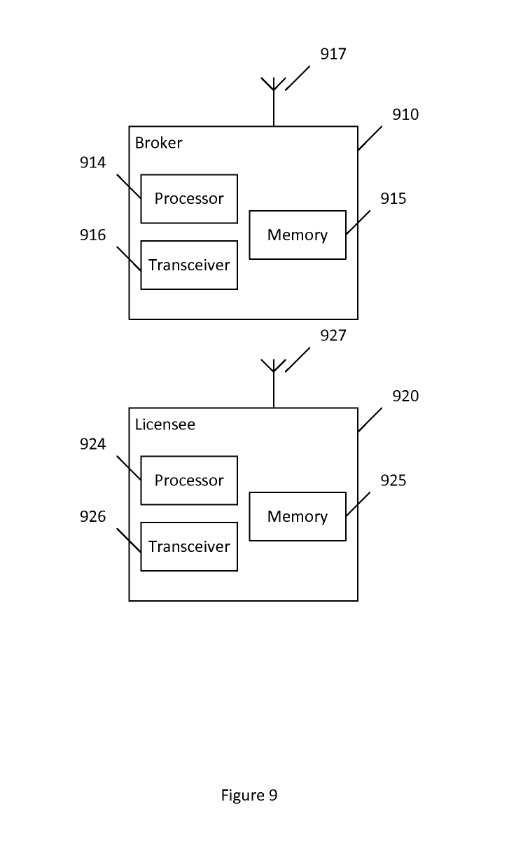

FIG. 9 illustrates a system according to certain embodiments of the invention. It should be understood that each block of the flowcharts of FIGS. 4-7 and any combination thereof may be implemented by various means or their combinations, such as hardware, software, firmware, one or more processors and/or circuitry. In one embodiment, a system may include several devices, such as, for example, broker 910 and licensee 920. Although not shown, other devices such as the databases, repositories, and access points discussed herein may be similar constructed. The system may include more than one licensee 920 (as in FIGS. 3 and 8) and more than one broker 910, although only one of each is shown in FIG. 9 for the purposes of illustration. The broker 910 and the licensee 920 can each be or include a server, a database, a host computer, or any of the network elements discussed herein. Each of these devices may include at least one processor or control unit or module, respectively indicated as 914 and 924. At least one memory may be provided in each device, and indicated as 915 and 925, respectively. The memory may include computer program instructions or computer code contained therein. One or more transceiver 916 and 926 may be provided, and each device may also include an antenna, respectively illustrated as 917 and 927. Although only one antenna each is shown, many antennas and multiple antenna elements may be provided to each of the devices. Other configurations of these devices may be provided. For example, broker 910 and licensee 920 may be additionally configured for wired communication, in addition to wireless communication, and in such a case antennas 917 and 927 may illustrate any form of communication hardware, without being limited to merely an antenna. Likewise, some brokers 910 and licensees 920 may be solely configured for wired communication, and such cases antennas 917 and 927 may illustrate any form of wired communication hardware, such as a network interface card.

Transceivers 916 and 926 may each, independently, be a transmitter, a receiver, or both a transmitter and a receiver, or a unit or device that may be configured both for transmission and reception. The transmitter and/or receiver may also be implemented as a remote radio head which is not located in the device itself, but in a mast, for example. It should also be appreciated that according to a liquid or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is configured as software that can run on a server.

Processors 914 and 924 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set, for example, procedures, functions, and the like. Memories 915 and 925 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity may be internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as broker 910 and/or licensee 920, to perform any of the processes described above (see, for example, FIGS. 4-8). Therefore, in certain embodiments, a computer-readable medium (for example, a signal or a non-transitory computer-readable medium) may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, or the like, or a low-level programming language, such as a machine language, or assembler. Another option is that the computer program or computer program code is loadable into the device or a memory the device has access to. Alternatively, certain embodiments of the invention may be performed entirely in hardware. Yet another option is that apparatus, such as a network element, is implemented at least partially by undedicated and programmable hardware which uses programmable resources.

It should be appreciated that embodiments may also be carried out at least partially by using cloud services or other software resources which do not necessarily locate in the device itself, but are otherwise available, such as transmittable from a server or host. In certain embodiments, many of the functions may be performed in distributed locations using a virtualization approach to computing.

Furthermore, although FIG. 9 illustrates a system including a broker 910 and a licensee 920, embodiments of the invention may be applicable to other configurations, and configurations involving additional elements, as illustrated and discussed herein, for example in FIGS. 3-8.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

### GLOSSARY

3 GPP 3rd Generation Partnership Project
ASA Authorised Shared Access
CM Configuration Management
DB Database
EC European Commission
EM Element Management
ETSI European Telecommunications Standards Institute
FCC Federal Communications Commission
KPI Key Performance Indicator
LSA Licensed Shared Access
LTE Long Term Evolution
MNO Mobile Network Operator
NM Network Management
OAM Operations, Administration and Maintenance
PM Performance Management
PSD Power Spectral Density
QoS Quality of Service
RAN Radio Access Network
RRM Radio Resource Management

We claim:

1. A method, comprising:
receiving an identification of radio spectrum resources corresponding to at least one incumbent and available for sharing either at a present time or at one or more future times;
sharing the radio spectrum resources to at least one radio access network operator; and
maintaining a priority for the at least one incumbent over the at least one operator with respect to the radio spectrum resources.

2. The method of claim 1, wherein the identification is received from the at least one incumbent.

3. The method of claim 1, further comprising:
receiving a request for the radio spectrum resources from the at least one incumbent; and
ordering the at least one operator to vacate the radio spectrum resources based on the request.

4. The method of claim 3, wherein the ordering comprises ordering the at least one operator to vacate the radio spectrum resources based on the request.

5. The method of claim 1, wherein the sharing comprises offering the resources to a plurality of radio access network operators using at least one of a reverse auction, a forward auction and fixed pricing scenario.

6. The method of claim 1, wherein the method is performed by a broker.

7. The method of claim 1, wherein the sharing the radio spectrum resources comprises offering the radio spectrum resources to the at least one operator either for a prescribed time period, with at least one minimum utilization requirement on the radio spectrum resources, or both for the prescribed time period and with the at least one minimum utilization requirement.

8. A method, comprising:
sharing, by a radio access network operator, radio spectrum resources corresponding to at least one incumbent, wherein the at least one incumbent maintains priority over the radio access network operator with respect to the radio spectrum resources;
determining whether to continue sharing the radio spectrum resources; and
discontinuing sharing the radio spectrum resources when the determination is negative.

9. The method of claim 8, wherein the discontinuing sharing comprises returning the radio spectrum resources to the incumbent.

10. The method of claim 8, wherein the discontinuing sharing comprises providing the radio spectrum resources to a second radio access network operator.

11. The method of claim 8, wherein the determining is based on receiving an order to vacate the radio spectrum resources.

12. The method of claim 8, wherein the determining is based on evaluating usage of the radio spectrum resources.

13. A method, comprising:
determining that shared radio spectrum resources are needed by a radio access network operator; and
obtaining the shared radio spectrum resources, wherein an incumbent corresponding to the shared radio spectrum resources maintains priority over the radio access network operator with respect to the radio spectrum resources.

14. The method of claim 13, wherein the obtaining comprises bidding on the shared radio spectrum resources to a broker.

15. The method of claim 13, wherein the obtaining comprises requesting the shared radio spectrum resources from a peer.

16. An apparatus, comprising:
at least one processor; and
at least one memory including computer program code,
wherein the at least one memory and the computer program code are configured to, with the at least one processor, cause the apparatus at least to
receive an identification of radio spectrum resources corresponding to at least one incumbent and available for sharing either at a present time or at one or more future times;
share the radio spectrum resources to at least one radio access network operator; and
maintain a priority for the at least one incumbent over the at least one operator with respect to the radio spectrum resources.

17. The apparatus of claim 16, wherein the identification is received from the at least one incumbent.

18. The apparatus of claim 16, wherein the at least one memory and the computer program code are configured to, with the at least one processor, cause the apparatus at least to:
receive a request for the radio spectrum resources from the at least one incumbent; and
order the at least one operator to vacate the radio spectrum resources based on the request.

19. The apparatus of claim 18, wherein the at least one memory and the computer program code are configured to, with the at least one processor, cause the apparatus at least to order by ordering the at least one operator to vacate the radio spectrum resources based on the request.

20. The apparatus of claim 16, wherein the at least one memory and the computer program code are configured to, with the at least one processor, cause the apparatus at least to share by offering the resources to a plurality of radio access network operators using at least one of a a reverse auction, a forward auction and fixed pricing scenario.

21. The apparatus of claim 16, wherein the apparatus is comprises a broker.

22. The apparatus of claim 16, wherein the at least one memory and the computer program code are configured to, with the at least one processor, cause the apparatus at least to share the radio spectrum resources by offering the radio spectrum resources to the at least one operator either for a prescribed time period, with at least one minimum utilization requirement on the radio spectrum resources, or both for the prescribed time period and with the at least one minimum utilization requirement.

23. An apparatus, comprising:
at least one processor; and
at least one memory including computer program code,
wherein the at least one memory and the computer program code are configured to, with the at least one processor, cause the apparatus at least to
share, by a radio access network operator, radio spectrum resources corresponding to at least one incumbent, wherein the at least one incumbent maintains priority over the radio access network operator with respect to the radio spectrum resources;
determine whether to continue sharing the radio spectrum resources; and
discontinue sharing the radio spectrum resources when the determination is negative.

24. The apparatus of claim 23, wherein the at least one memory and the computer program code are configured to, with the at least one processor, cause the apparatus at least to discontinue sharing by returning the radio spectrum resources to the incumbent.

25. The apparatus of claim 23, wherein the at least one memory and the computer program code are configured to, with the at least one processor, cause the apparatus at least to discontinue sharing by providing the radio spectrum resources to a second radio access network operator.

26. The apparatus of claim 23, wherein the at least one memory and the computer program code are configured to, with the at least one processor, cause the apparatus at least to determine whether to continue sharing based on receiving an order to vacate the radio spectrum resources.

27. The apparatus of claim 23, wherein the at least one memory and the computer program code are configured to, with the at least one processor, cause the apparatus at least to determine whether to continue sharing based on evaluating usage of the radio spectrum resources.

28. An apparatus, comprising:
at least one processor; and
at least one memory including computer program code,
wherein the at least one memory and the computer program code are configured to, with the at least one processor, cause the apparatus at least to
determine that shared radio spectrum resources are needed by a radio access network operator; and
obtain the shared radio spectrum resources, wherein an incumbent corresponding to the shared radio spectrum resources maintains priority over the radio access network operator with respect to the radio spectrum resources.

29. The apparatus of claim 28, wherein the at least one memory and the computer program code are configured to, with the at least one processor, cause the apparatus at least to obtain the shared radio spectrum by bidding on the shared radio spectrum resources to a broker.

30. The apparatus of claim 28, wherein the at least one memory and the computer program code are configured to, with the at least one processor, cause the apparatus at least to obtain the shared radio spectrum by requesting the shared radio spectrum resources from a peer.
